(19) United States
(12) Patent Application Publication
(10) Pub. No.: US 2019/0038500 A1
(43) Pub. Date: Feb. 7, 2019

(54) MASSAGE DEVICE

(71) Applicant: HIGHROLLER SUOMI OY, Vuokatti (FI)

(72) Inventors: Olli LEHTI, Haapavesi (FI); Juha JUNTUNEN, Vuokatti (FI)

(73) Assignee: HIGHROLLER SUOMI OY, Vuokatti (FI)

(21) Appl. No.: 16/075,851

(22) PCT Filed: Feb. 6, 2017
(86) PCT No.: PCT/FI2017/050065

§ 371 Date: Aug. 6, 2018

(30) Foreign Application Priority Data
Feb. 5, 2016 (FI) U20160020

(51) Int. Cl. A61H 15/02

(52) U.S. Cl. CPC A61H 15/02; A61H 2015/0042

(57) ABSTRACT

A massage device comprising a base (4) provided with means (8) for adjusting the frames (2) of massage balls (1) in order to allow the distance (1) between the massage balls (1) to be adjusted, and wherein the shafts (7) of the massage balls (1) are secured to the frames (2) in such a way that they extend upwards in a V shape with respect to one another.

### FIELD OF THE INVENTION

The present invention relates to sports equipment, massage equipment and physiotherapy equipment as well as to equipment intended for myofascial pain therapy. In particular, the invention relates to a massage device consisting of a base and massage balls, the frames of the massage balls being adjustable in order to allow the distance between the massage balls to be adjusted.

### BACKGROUND OF THE INVENTION

It is known to tape two baseballs together to make a simple massage device. Because they do not rotate on a base, the balls easily slip away from the body area under treatment. Besides, there are balls that are adapted to rotate on the floor, mounted on one straight shaft, wherein the massaged body part scrapes over the shaft between the balls. In a back massage, the shaft between the balls may even cause damage to the spine.

Other known solutions include, for example, massage elements fixed to bases and handles, allowing different body parts to be manually massaged. When massaging by means of them, no rolling massaging movement occurs but they only are rubbed and pressed against certain areas. Therefore, these prior inventions are not practical.

### SUMMARY OF THE INVENTION

The objective of the present invention is to alleviate the above-mentioned prior art drawbacks.

The present invention relates to a massage device designed for effective and active full-body muscle maintenance as well as for tension relief. The device allows the user to faster recover from workouts, improve his performance and mobility. Further, the use of the device may prevent injuries. The massage device allows active muscle maintenance to be performed, all the way from the neck down to the back and ankles.

The device manipulates any desired body part by stretching, pressing or rolling massage movements back and forth. When massaging the calves or posterior thigh muscles, a stool, or some other stand, of a suitable height can be used in order to facilitate the movements.

The device may find trigger points and intensively massage the long muscles next to the spine, for example. When starting to manipulate the back, it is recommended to ease the movement by grabbing the edge of a table or by mounting the device to the wall. Further, the device may unlock facet joints and mobilize the spine.

Especially, it is possible to take pressure off the intervertebral discs and nerves by stretching the back by means of the massage balls. A massage stimulates the blood circulation and metabolism. The massage device is not only useful for athletes but the device allows many simple movements, which are suitable for older and more unfit people as well, to be performed.

The massage device of the invention is characterized in what is set forth in the characterizing part of claim 1.

The dependent claims of the set of claims disclose different embodiments of the invention.

According to an embodiment of the invention, the means for adjusting the frames of the massage balls comprise an adjusting groove. Alternatively, the means may comprise a screw-gear shaft. Alternatively, the means may further comprise individual cavities or similar fastening points on the base. It is essential that the means allow the distances between the balls to be adjusted for different body parts and different bodies, for example.

According to an embodiment of the invention, spring-biased locking pins are provided between the base and the frames of the massage balls, allowing the distance between the massage balls to be adjusted along the adjusting groove. According to an embodiment of the invention, adjusting knobs allow the locking pins to be lifted for the adjustment of the distance between the massage balls along the adjusting groove. Hence, with the frames of the balls easily sliding in the adjusting groove provided in the base, the distance between the massage balls can be adjusted by lifting the adjusting knob, moving the balls to desired positions by releasing the locking pin, with the result that the spring pushes the pin into a hole made in the base and that the frames carrying the balls are locked to the base.

According to an embodiment of the invention, the massage device comprises a non-slip bottom under the base. The non-slip bottom is made from a substantially gripping and non-sliding material helping the massage device stay in place while the device is used.

According to an embodiment of the invention, the frames of the massage balls are adjustable for changing the rotational angle of the balls in relation to the base.

According to an embodiment of the invention, the shaft frame forms the massage ball shaft as well.

According to an embodiment of the invention, the balls comprise some other shape than a sphere. This shape can be a droplet, peer or cone shape, for example.

According to an embodiment of the invention, the surface shape of the massage ball includes formations or a surface texture that have an effect on the massage. Said formations can be bumps, wave-shaped recesses and elevations, or, a coating or surface texture that have an effect on friction.

According to an embodiment of the invention, the massage balls comprises cold or heat accumulating material. Said material may comprise any typical suitable material selected because of its high specific heat capacity.

The material and hardness of the massage balls can be selected as desired. Preferably, the balls may comprise a hard structure or a more flexible and figure-hugging material. Further, the balls may comprise cold or heat accumulating material, allowing the effects of the massage to be varied by heating or cooling.

The shafts of the balls are intentionally adapted to extend in a preferable angle, allowing, for example, the spine to freely run between the balls without coming into contact with the shaft in the middle, and the balls to drill deep into the back and other body muscles. If the balls were horizontally mounted on a single straight shaft, the drilling of the device into the muscle would not be this effective, and, in a back massage, for example, the shaft of the device could cause damage to the spine.

While the massage balls move reciprocally, the inclined shafts of the device suck the massage deeper, resulting in a more effective massage. The distance between the balls is adjustable according to the body proportions of the user, the massaged object and individual desires—instead, it would be difficult to adjust the distance between baseballs taped together, for example.

The arrangement according to the present invention allows rolling massage treatments and motoric movements to be performed without any auxiliary equipment and by the user himself, without any help from other people. The massage device may substantially be small in size, in order to be easy to carry and put in different places, such as on the floor, on a stand or against the wall, for different kinds of massaging and muscle maintenance activities.

The term “exemplary” is used herein to refer to different examples, not to the best alternative.

The dependent claims disclose different preferable embodiments of the invention.

### BRIEF DESCRIPTION OF THE FIGURES

In the following, a few preferred embodiments of the invention will be described with reference to the accompanying drawing wherein

FIG. 1 is an exemplary lateral view of a massage device according to an embodiment of the invention,

FIG. 2 is an exemplary lateral view of the massage device according to the embodiment of the invention, without the massage balls,

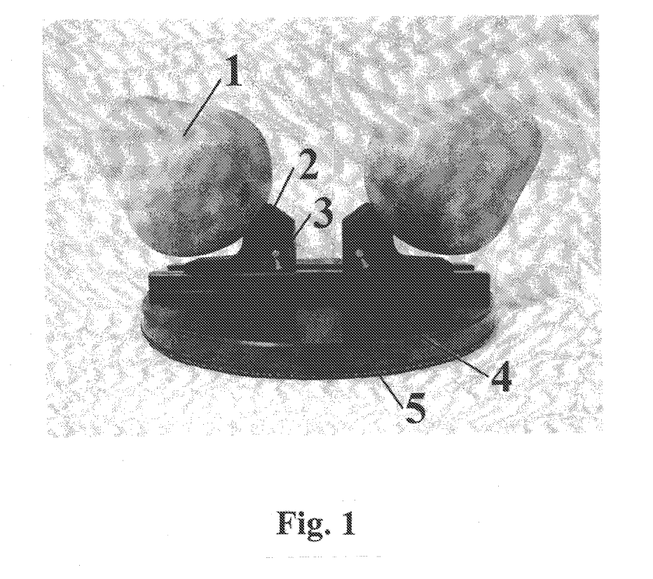

FIG. 1 is an exemplary end view of the massage device according to the embodiment of the invention,

FIG. 4 is an exemplary view of the ball frame parts of the massage device according to the embodiment of the invention,

FIG. 5 is an exemplary lateral view of a massage device according to a second embodiment of the invention,

FIG. 6 is an exemplary top view of the massage device according to the second embodiment of the invention,

FIG. 7 is an exemplary lateral view of a massage device according to a third embodiment of the invention,

FIG. 8 is an exemplary top view of the massage device according to the third embodiment of the invention.

### MORE DETAILED DESCRIPTION OF THE FIGURES

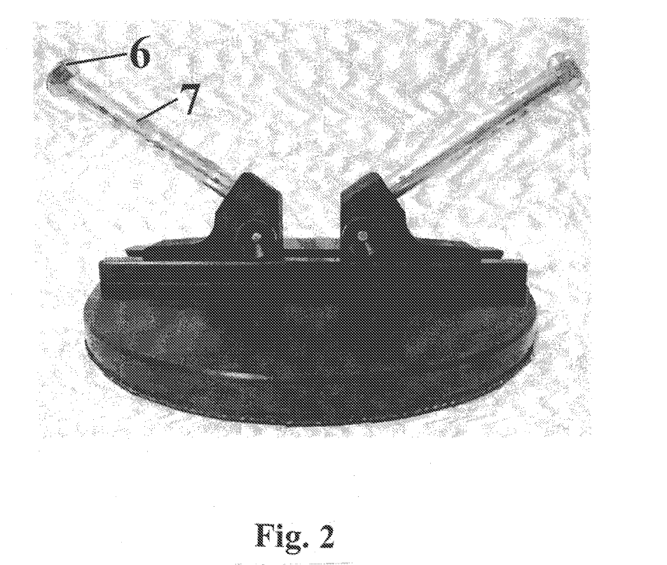

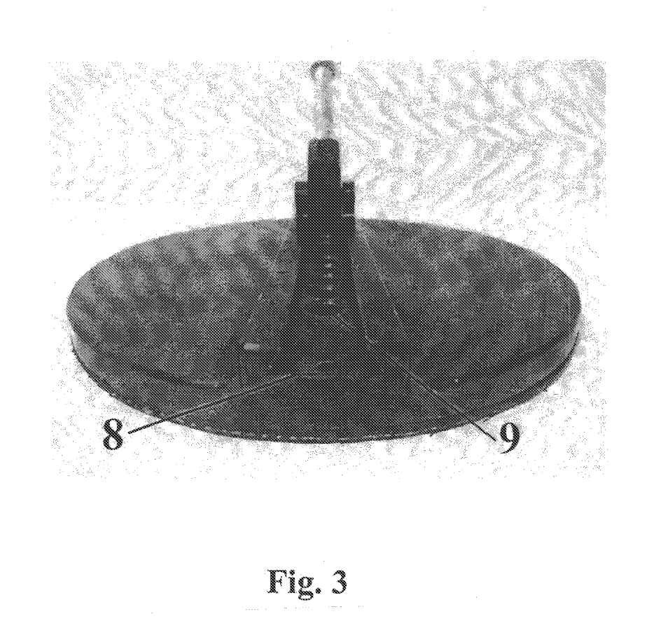

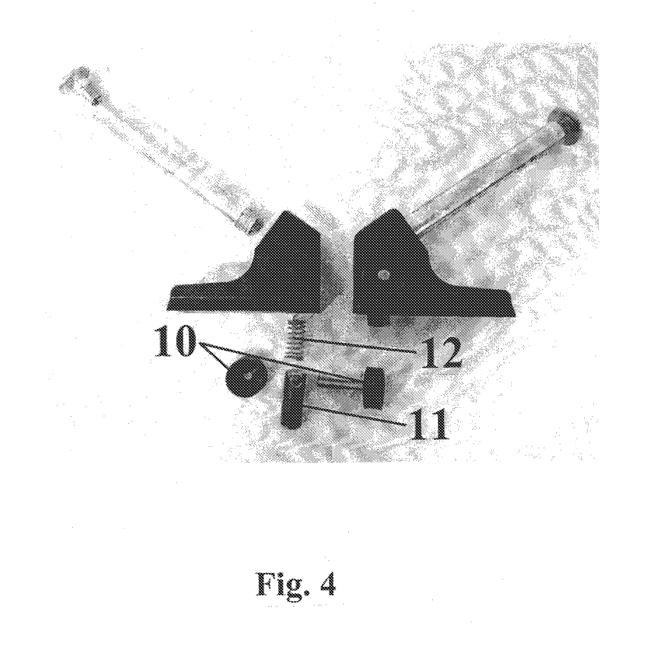

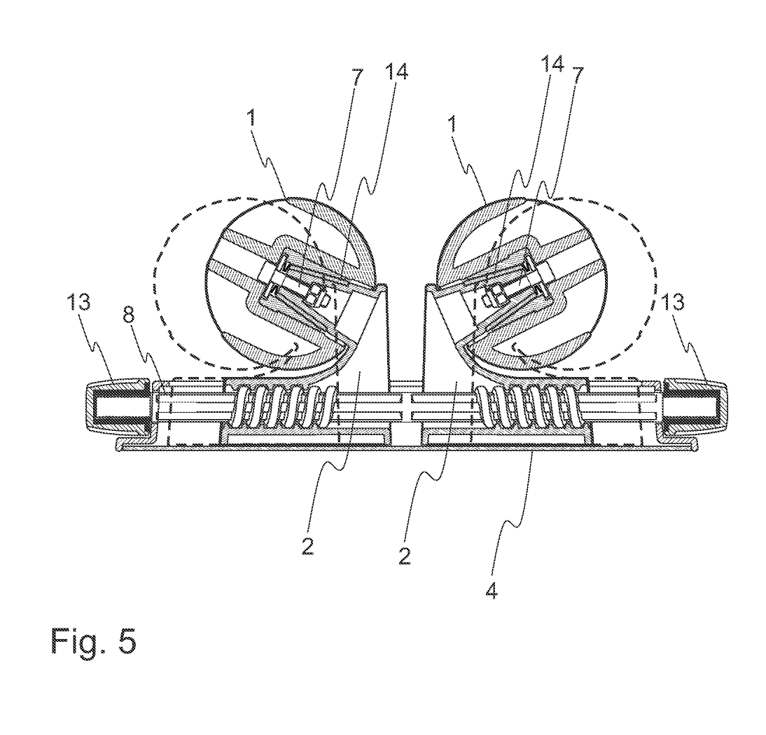

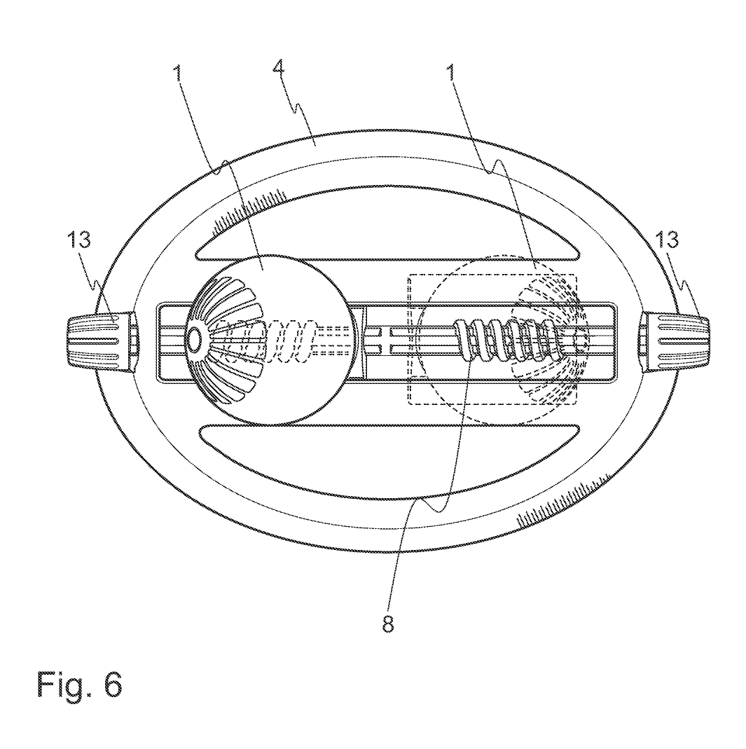

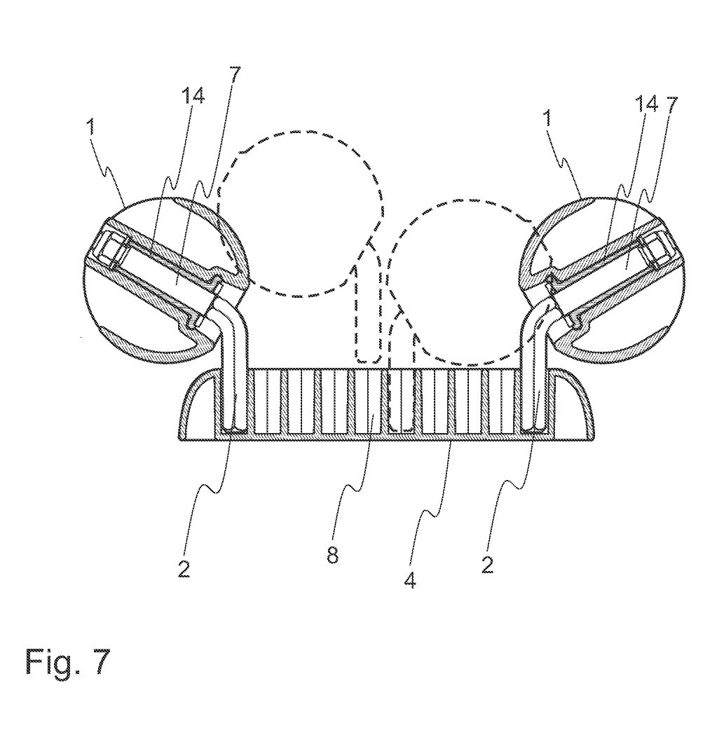

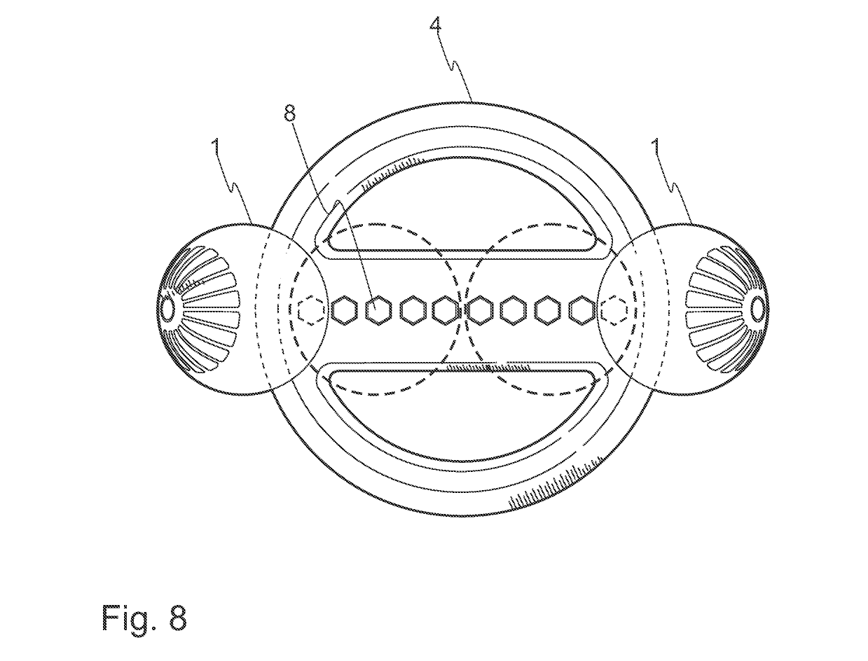

FIGS. 1 to 4 show a few perspective views of the parts of an exemplary embodiment of the massage device of the invention.

The massage device substantially comprises two balls (1) rotatable on shafts (7). The balls (1) can be replaced by removing a screw (6) from the end of their shaft (7), or, by removing their shaft (7) from the shaft frame (2). The shaft frame (2) is adapted to slide along an adjusting groove (8). Locking pins (11) lock the shaft frames (7) into adjusting holes (9) made in a base (4). A fastening pin (3) is provided between an adjusting knob (10) and the locking pin (11). The concave adjusting knobs (10) can be grabbed by the fingertips while lifting the locking pin (11). A return spring (12) provided for the locking pin (11) presses the locking pin (11) into the adjusting holes (9) in the base.

The massage ball (1) may comprise hard or soft structures and be made from a polymer, such as an elastomer, and/or plastic. The massage balls (1) can be made from materials, or material combinations, which are known materials for massage balls and rollers, such as foam rollers. It is also known to select their Shore, that is, hardness, with respect to pain tolerance, that is, their material hardness with respect to the desired massage method or application.

As shown, the massage ball (1) does not have to be a ball but it preferably comprises a spherical or cylindrical shape. However, the surface and cross-section of the ball (1) may vary from application to application, and, its different shapes may allow an optimal massage result to be achieved for each massaged object and in each application of the massage device.

The base (4) may comprise different materials, such as metal or plastic. The base (4) can be made from a single material or comprise several materials—as an example, the areas subject to wear, or, requiring reinforcement, comprise another material than the other parts.

The massage balls form a V shape wherein the rotational axis of the ball (1) is angled in relation to the plane of the base (4). Said angle can be set as desired, and, in some cases, the angle may substantially be parallel to the base (4). Preferably, the

V shape can be formed with one shaft frame at an angle of approximately 26 degrees in relation to the base. Other preferable angles can be achieved in the range of 20 to 45 degrees, for example. However, the angles of the shafts (7) may differ from one another, in other words, the shafts (7) do not have to be similarly angled in relation to the base (4). Further, the shaft (7) may also be parallel to the base (4) although this is not primarily the most important embodiment. But the shaft (7) cannot be parallel to the normal of the base (4), with the shaft (7) directed straight upwards.

The base (4) does not have to planar, as shown above. The base (4) may comprise a number of different shapes, but it is essential that it provides enough support and a platform to which the shaft frames (2) of the balls (1) are fixed or can be removably fixed, and, in addition, allows the distance between the balls to be changed, by changing either the position of the shaft frame (2), or, of the shaft (7) therein, or the distance between the shaft frames (2).

The massage device can be used by putting it in different places and different positions. The massage devices is convertible by means of different kinds of quick releases, making the device quick and easy to wall-mount, for example. A variety of suitable materials and shapes can be used as the raw materials of the invention. Besides, the massage device is convertible by using a different ball locking mechanism, ball (1) bearing (14), shaft (7) inclination, adjusting groove, ball-frame locking mechanism, base (4) type or device size.

As said, the massage device may vary in size, but, preferably its size range is such that the size of the massage balls is approximately equal to that of tennis balls. Of course, this is not a real restriction and it will be appreciated by a person skilled in the art that the statement mainly concerns the planned applicable size range.

FIGS. 5 and 6 show a massage device according to a second embodiment of the invention. This embodiment can especially be regarded as a more complex embodiment of the invention, allowing the distance between the balls to be accurately adjusted.

The massage device comprises balls (1) mounted on rotatable shafts. In this embodiment, the means (8) comprise a screw gear adapted to move the shaft frames (2). The distance between the shaft frames (2) can be adjusted by means of the screw gear (8), by turning one or two knobs (13) provided in the ends of the gear. The screw gear (8) can be injection-molded, for example.

This embodiment can be particularly suited for applications where it is advantageous to be able to accurately adjust the distance between the balls (1). An example of this kind of application is a massage device intended for professional use.

In FIG. 5, the adjustment of the distance as well as some possible positions of the balls are designated by dashed lines.

The bearings (14) of the shafts (7) may comprise a plain bearing or a roller bearing, such as a POM bearing (polyoxymethylene).

FIGS. 7 and 8 show a massage device according to a third embodiment of the invention. This embodiment can especially be regarded as a simpler embodiment of the invention, allowing the distance between the balls to be adjusted by using fixed intervals.

The massage device comprises balls (1) mounted on rotatable shafts in shaft frames (2). In this embodiment, the shafts (7) are secured to hexagonal shaft frames (2) and the means (8) comprise fixed hexagonal holes (only one of them is designated by a number) capable of receiving the shaft frames (2). The distance between the shaft frames (2) can be adjusted by inserting the shaft frames (2) into any desired holes (8) in the base, these holes (8) being hexagonal, as mentioned above, or, quadratic in shape, for instance. The hole (8) may very well vary in shape but, preferably, its shape is such that the shaft frames (2) cannot rotate or substantially move in any other way in relation to the holes (8). Alternatively, the shaft frames (2) are locked into position in some other way than by utilizing the geometry of the hole (8), such as by using mechanical locking. If a round profile is used for the shaft frame (2) and mechanical locking to secure the shaft frame (2) into the holes (8), it is possible to use the round shaft frame as the shaft (7) itself.

There can be any desired number of holes (8), depending on how extensive an adjustment range is desired, and, in addition, on the geometry of the massage device. If desired, the holes (8) may also be provided with fastening mechanisms, such as a mechanical buckle or the like to lock the shaft frame (2) into position. For example, in an embodiment, the adjustment range can be 120 to 160 mm, wherein the balls are approximately the size of a tennis ball.

As an example, the shaft frames (2) can be machined as desired by an automatic rod bending machine and bent to any desired angle, this angle being fixed and invariable. The shaft frames (7) and the area where the holes (8) are made in the base (4) may consist of metal, for example.

In the Figures, the adjustment of the distance by inserting the shaft frames (2), with the balls (1) provided thereon, into different holes (8) is designated by dashed lines.

This embodiment can especially be regarded as suited for applications where the accuracy of the adjustment of the distance between the balls is not the main requirement. The simple structure of this solution makes it particularly applicable in mass production.

The claims define the scope of protection of the invention. However, it is obvious to a person skilled in the art that the features of the invention may vary in detail to some extent within the overall inventive idea, depending on each embodiment of the invention.

1. A massage device, comprising
a base provided with a means for adjusting a plurality of frames of massage balls in order to allow a distance between the massage balls to be adjusted, and
wherein shafts of the massage balls are secured to the plurality of frames in such a way that the shafts extend upwards in a V shape with respect to one another.

2. A massage device as defined in claim 1, wherein the means comprises an adjustment groove.

3. A massage device as defined in claim 1, wherein the means comprises a screw-gear shaft.

4. A massage device as defined in claim 1, wherein the means comprises cavities or fastening points on the base.

5. A massage device as defined in claim 2, wherein spring-biased locking pins are provided between the base and the plurality of frames, enabling the distance between the massage balls to be adjusted.

6. A massage device as defined in claim 5, wherein the spring-biased locking pins can be lifted by adjustment knobs in order to adjust the distance between the massage balls.

7. A massage device as defined in claim 1, wherein the plurality of frames are adjustable for changing the rotational angle of the massage balls in relation to the base in order to adjust the V shape.

8. A massage device as defined in claim 1, wherein a non-slip bottom is provided under the base.

9. A massage device as defined in claim 1, wherein the each frame forms one of the plurality of shafts as well.

10. A massage device as defined in claim 1, wherein each of the massage balls comprise some other shape than a sphere.

11. A massage device as defined in claim 1, wherein the outer surface of each of the massage balls is provided with a plurality of formations or a surface texture that have an effect on the massage.

12. A massage device as defined in claim 1, wherein the massage balls comprise cold or heat accumulating material.
